(19) United States
(12) Patent Application Publication
(10) Pub. No.: US 2007/0230382 A1
(43) Pub. Date: Oct. 4, 2007

(54) Method and system for decoding data streams in a MIMO system

(75) Inventors: Yinong Ding, Plano, TX (US); Farooq Khan, Allen, TX (US)

Correspondence Address: DOCKET CLERK, P.O. DRAWER 800889, DALLAS, TX, 75380, US

(73) Assignee: SAMSUNG ELECTRONICS CO., LTD., Suwon-city (KR)

(21) Appl. No.: 11/591,852

(22) Filed: Nov. 2, 2006

Related U.S. Application Data
(60) Provisional application No. 60/787,295, filed on Mar. 30, 2006.

(51) Int. Cl. H04B 7/00; H04B 7/208

(52) U.S. Cl. 370/310; 370/344

(57) ABSTRACT

A method for decoding a plurality of data streams from a combined data stream in a Multiple Input/Multiple Output (MIMO) system is provided. The method includes selecting a decoding order for the data streams based on a decoding prediction metric for each of the data streams and decoding the data streams based on the decoding order.

### CROSS-REFERENCE TO RELATED APPLICATION(S) AND CLAIM OF PRIORITY

The present application is related to U.S. Provisional Patent No. 60/787,295, filed Mar. 30, 2006, titled “Interference Cancellation Order Prediction in a MIMO System.” Provisional Patent No. 60/787,295 is assigned to the assignee of the present application and is hereby incorporated by reference into the present application as if fully set forth herein. The present application hereby claims priority under 35 U.S.C. §119(e) to U.S. Provisional Patent No. 60/787,295.

### TECHNICAL FIELD OF THE INVENTION

The present disclosure relates generally to wireless communication and, more specifically, to a method and system for decoding data streams in a Multiple Input/Multiple Output (MIMO) system.

### BACKGROUND OF THE INVENTION

In MIMO systems, each of a plurality of data streams is individually encoded and modulated before being transmitted by a different antenna. The combined data streams are then received at multiple antennas of a receiver. At the receiver, each data stream is separated and extracted from the combined signal. This process is generally performed using a minimum mean squared error (MMSE) or MMSE-successive interference cancellation (SIC) algorithm.

The MMSE-SIC algorithm detects signal components or data streams one at a time by repeatedly applying the MMSE algorithm. After one signal component is extracted, the data stream passes through a virtual channel for that data stream and is then subtracted or cancelled from the combined signal. Therefore, for each subsequent application of MMSE, the dimension of the underlying system is reduced by one. This process is called successive interference cancellation since each detected data stream acts as interference for the detection of the remaining data streams.

The order in which the successive interference cancellation is performed on the data streams has an enormous impact on the performance of MMSE-SIC. However, in typical MIMO systems, the order is randomly determined without regard for the actual system conditions. As a result, a stream that is inaccurately decoded and then reconstructed and canceled from the combined signal will introduce errors into the combined signal for the remaining data streams. One solution to this problem involves searching for all possible cancellation orders by verifying the accuracy of the decoded data streams before reconstruction and cancellation. However, because searching for all possible cancellation orders requires a large number of decoding attempts, this approach results in an extremely complex receiver. Therefore, there is a need in the art for an improved method of decoding data streams in a MIMO system.

### SUMMARY OF THE INVENTION

A method for decoding a plurality of data streams from a combined data stream in a Multiple Input/Multiple Output (MIMO) system is provided. According to an advantageous embodiment of the present disclosure, the method includes selecting a decoding order for the data streams based on a decoding prediction metric for each of the data streams and decoding the data streams based on the decoding order.

According to another embodiment of the present disclosure, a system for decoding a plurality of data streams from a combined data stream in a MIMO system is provided that includes a decoding order selector and a decoder. The decoding order selector is operable to select a decoding order for the data streams based on a decoding prediction metric for each of the data streams. The decoder is operable to decode the data streams based on the decoding order.

According to yet another embodiment of the present disclosure, a receiver capable of decoding a plurality of data streams from a combined data stream in a MIMO system is provided that includes a plurality of receive antennas and a spatial processing block coupled to the receive antennas. The receive antennas are operable to receive the combined data stream from a transmitter. The combined data stream comprises the plurality of data streams that each have been transmitted by one of a plurality of transmit antennas at the transmitter. The spatial processing block is operable to decode the plurality of data streams from the combined data stream based on a decoding prediction metric for each of the data streams.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the term “each” means every one of at least a subset of the identified items; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most, instances such definitions apply to prior, as well as future, uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an Orthogonal Frequency Division Multiple Access (OFDMA) wireless network that is capable of decoding data streams according to an embodiment of the present disclosure;

FIG. 2 illustrates a MIMO system that is capable of decoding data streams according to an embodiment of the present disclosure;

FIG. 3 illustrates details of the encoder of FIG. 2 according to an embodiment of the present disclosure;

FIG. 4 illustrates details of the spatial processing block of FIG. 2 according to an embodiment of the present disclosure; and

FIG. 5 is a flow diagram illustrating a method for decoding data streams using the spatial processing block of FIG. 2 or 4 according to an embodiment of the present disclosure.

### DETAILED DESCRIPTION OF THE INVENTION

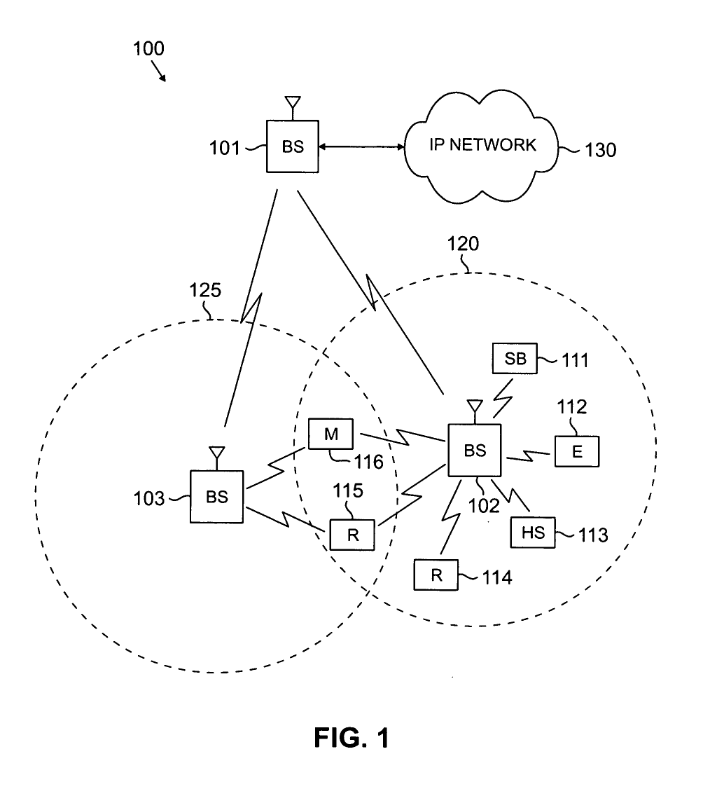

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless receiver.

FIG. 1 illustrates exemplary wireless network 100 that is capable of decoding data streams according to one embodiment of the present disclosure. In the illustrated embodiment, wireless network 100 includes base station (BS) 101, base station (BS) 102, and base station (BS) 103. Base station 101 communicates with base station 102 and base station 103. Base station 101 also communicates with Internet protocol (IP) network 130, such as the Internet, a proprietary IP network, or other data network.

Base station 102 provides wireless broadband access to network 130, via base station 101, to a first plurality of subscriber stations within coverage area 120 of base station 102. The first plurality of subscriber stations includes subscriber station (SS) 111, subscriber station (SS) 112, subscriber station (SS) 113, subscriber station (SS) 114, subscriber station (SS) 115 and subscriber station (SS) 116. In an exemplary embodiment, SS 111 may be located in a small business (SB), SS 112 may be located in an enterprise (E), SS 113 may be located in a WiFi hotspot (HS), SS 114 may be located in a first residence, SS 115 may be located in a second residence, and SS 116 may be a mobile (M) device.

Base station 103 provides wireless broadband access to network 130, via base station 101, to a second plurality of subscriber stations within coverage area 125 of base station 103. The second plurality of subscriber stations includes subscriber station 115 and subscriber station 116. In alternate embodiments, base stations 102 and 103 may be connected directly to the Internet by means of a wired broadband connection, such as an optical fiber, DSL, cable or T1/E1 line, rather than indirectly through base station 101.

In other embodiments, base station 101 may be in communication with either fewer or more base stations. Furthermore, while only six subscriber stations are shown in FIG. 1, it is understood that wireless network 100 may provide wireless broadband access to more than six subscriber stations. It is noted that subscriber station 115 and subscriber station 116 are on the edge of both coverage area 120 and coverage area 125. Subscriber station 115 and subscriber station 116 each communicate with both base station 102 and base station 103 and may be said to be operating in handoff mode, as known to those of skill in the art.

In an exemplary embodiment, base stations 101-103 may communicate with each other and with subscriber stations 111-116 using an IEEE-802.16 wireless metropolitan area network standard, such as, for example, an IEEE-802.16e standard. In another embodiment, however, a different wireless protocol may be employed, such as, for example, a HIPERMAN wireless metropolitan area network standard. Base station 101 may communicate through direct line-of-sight or non-line-of-sight with base station 102 and base station 103, depending on the technology used for the wireless backhaul. Base station 102 and base station 103 may each communicate through non-line-of-sight with subscriber stations 111-116 using OFDM and/or OFDMA techniques.

Base station 102 may provide a T1 level service to subscriber station 112 associated with the enterprise and a fractional T1 level service to subscriber station 111 associated with the small business. Base station 102 may provide wireless backhaul for subscriber station 113 associated with the WiFi hotspot, which may be located in an airport, cafe, hotel, or college campus. Base station 102 may provide digital subscriber line (DSL) level service to subscriber stations 114, 115 and 116.

Subscriber stations 111-116 may use the broadband access to network 130 to access voice, data, video, video teleconferencing, and/or other broadband services. In an exemplary embodiment, one or more of subscriber stations 111-116 may be associated with an access point (AP) of a WiFi WLAN. Subscriber station 116 may be any of a number of mobile devices, including a wireless-enabled laptop computer, personal data assistant, notebook, handheld device, or other wireless-enabled device. Subscriber stations 114 and 115 may be, for example, a wireless-enabled personal computer, a laptop computer, a gateway, or another device.

Dotted lines show the approximate extents of coverage areas 120 and 125, which are shown as approximately circular for the purposes of illustration and explanation only. It should be clearly understood that the coverage areas associated with base stations, for example, coverage areas 120 and 125, may have other shapes, including irregular shapes, depending upon the configuration of the base stations and variations in the radio environment associated with natural and man-made obstructions.

Also, the coverage areas associated with base stations are not constant over time and may be dynamic (expanding or contracting or changing shape) based on changing transmission power levels of the base station and/or the subscriber stations, weather conditions, and other factors. In an embodiment, the radius of the coverage areas of the base stations, for example, coverage areas 120 and 125 of base stations 102 and 103, may extend in the range from less than 2 kilometers to about fifty kilometers from the base stations.

As is well known in the art, a base station, such as base station 101, 102, or 103, may employ directional antennas to support a plurality of sectors within the coverage area. In FIG. 1, base stations 102 and 103 are depicted approximately in the center of coverage areas 120 and 125, respectively, In other embodiments, the use of directional antennas may locate the base station near the edge of the coverage area, for example, at the point of a cone-shaped or pear-shaped coverage area.

The connection to network 130 from base station 101 may comprise a broadband connection, for example, a fiber optic line, to servers located in a central office or another operating company point-of-presence. The servers may provide communication to an Internet gateway for internet protocol-based communications and to a public switched telephone network gateway for voice-based communications. In the case of voice-based communications in the form of voice-over-IP (VoIP), the traffic may be forwarded directly to the Internet gateway instead of the PSTN gateway. The servers, Internet gateway, and public switched telephone network gateway are not shown in FIG. 1. In another embodiment, the connection to network 130 may be provided by different network nodes and equipment.

In accordance with an embodiment of the present disclosure, one or more of base stations 101-103 and/or one or more of subscriber stations 111-116 comprises a receiver that is operable to decode a plurality of data streams received as a combined data stream from a plurality of transmit antennas using an MMSE-SIC algorithm. As described in more detail below, the receiver is operable to determine a decoding order for the data streams based on a decoding prediction metric for each data stream that is calculated based on a strength-related characteristic of the data stream. Thus, in general, the receiver is able to decode the strongest data stream first, followed by the next strongest data stream, and so on. As a result, the decoding performance of the receiver is improved as compared to a receiver that decodes streams in a random order without being as complex as a receiver that searches all possible decoding orders to find the optimum order.

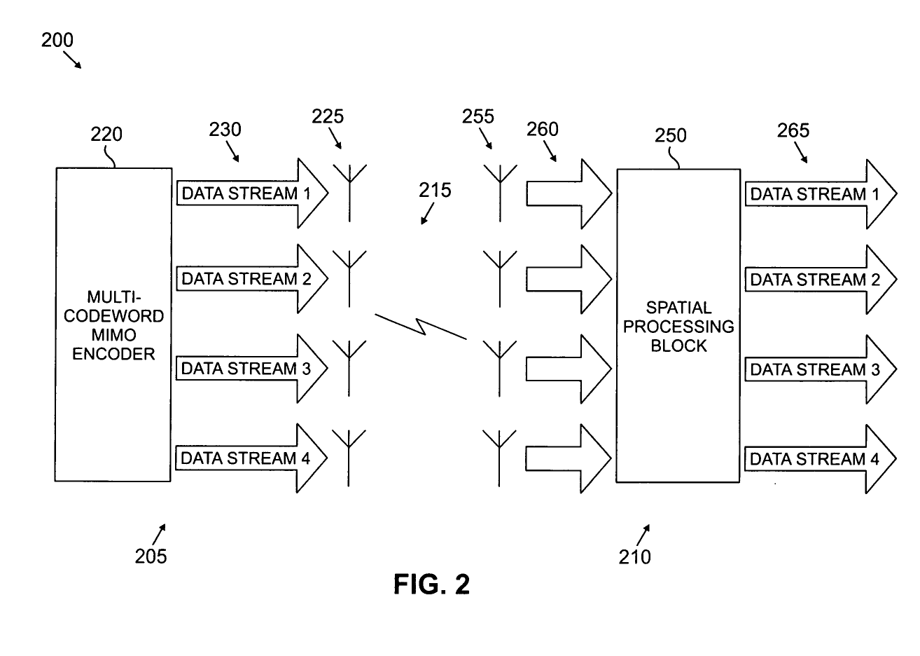

FIG. 2 illustrates a MIMO system 200 that is capable of decoding data streams according to an embodiment of the present disclosure. MIMO system 200 comprises a transmitter 205 and a receiver 210 that are operable to communicate over a wireless interface 215.

Transmitter 205 comprises a multi-codeword MIMO encoder 220 and a plurality of antennas 225, each of which is operable to transmit a different data stream 230 generated by encoder 220. Receiver 210 comprises a spatial processing block 250 and a plurality of antennas 255, each of which is operable to receive a combined data stream 260 from a plurality of sources including antennas 225 of transmitter 205. Spatial processing block 250 is operable to decode the combined data stream 260 into data streams 265, which are substantially identical to the data streams 230 transmitted by antennas 225.

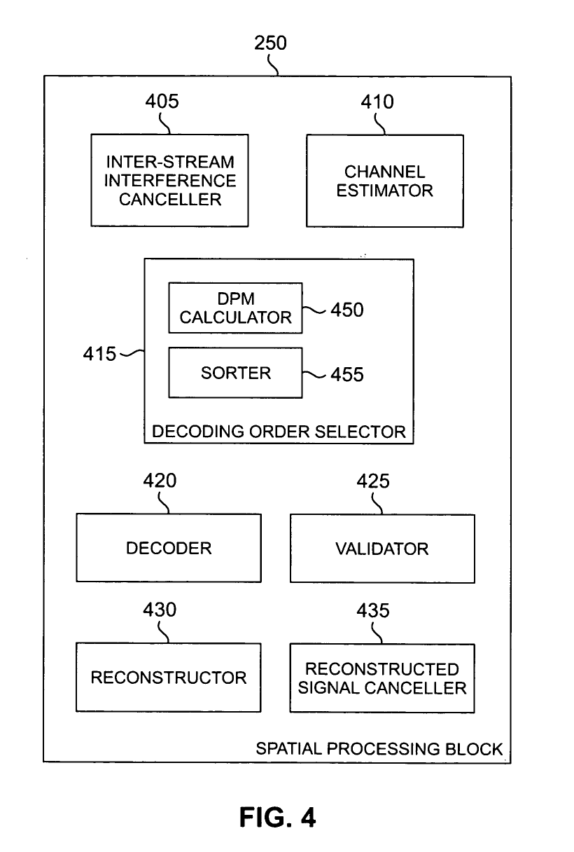

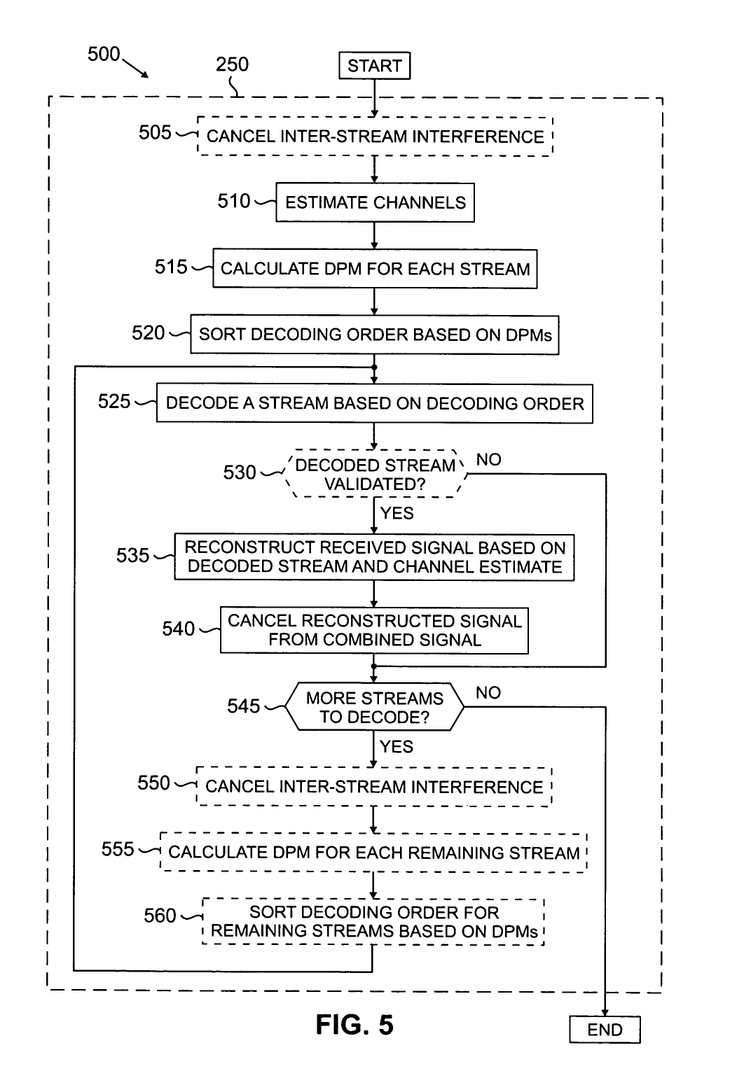

As described in more detail below in connection with FIGS. 4 and 5, spatial processing block 250 is operable to decode data streams 265 from the combined data stream 260 using an MMSE-SIC procedure that selects an order for decoding the streams 265 based on a decoding prediction metric (DPM) for each stream 265. The DPM for each data stream 265 is based on a strength-related characteristic associated with the data stream 265. Thus, for example, the DPM may be based on a capacity of the channel associated with the data stream 265, an effective signal-to-interference and noise ratio (SINR) for the data stream 265 and/or any other suitable strength-related characteristic. Using this process for decoding, receiver 210 is able to provide better performance than a receiver that decodes streams in a random order without introducing the complexity of a receiver that searches all possible decoding orders to find an optimum decoding order.

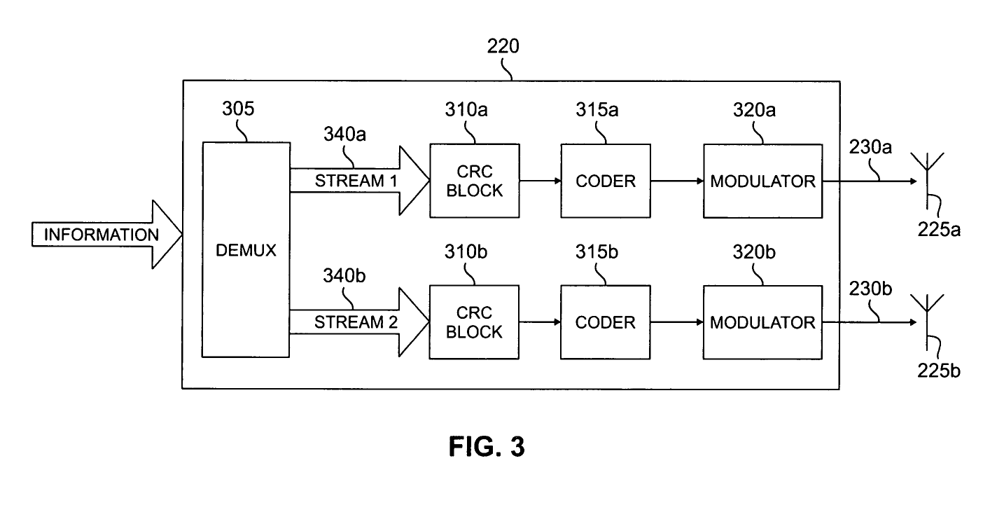

FIG. 3 illustrates details of multi-codeword MIMO encoder 220 according to an embodiment of the present disclosure. For this embodiment, encoder 220 comprises a demultiplexer (demux) 305, a plurality of cyclic redundancy code (CRC) blocks 310, a plurality of coders 315, and a plurality of modulators 320. Encoder 220 is operable to receive an information block and to generate data streams 230 based on the information block for transmission over antennas 225. Although the illustrated embodiment shows two sets of components 310, 315 and 320 to generate two streams 230a-b for transmission by two antennas 225a-b, it will be understood that encoder 220 may comprise any suitable number of component sets 310, 315 and 320 based on any suitable number of streams 230 to be generated.

Demultiplexer 305 is operable to demultiplex the information block into a plurality of smaller information blocks, or streams 340. Each CRC block 310 is operable to add CRC data to the associated stream 340. Following the addition of CRC data, each coder 315 is operable to code the stream 340 and each modulator 320 is operable to modulate the coded stream 340. After coding and modulation, the resulting streams, which are equivalent to data streams 230, are transmitted from separate antennas 225.

Because encoder 220 is a multi-codeword MIMO encoder, different modulation and coding may be used on each of the individual streams 340. Thus, for example, coder 315a may perform different coding from coder 315b and modulator 320a may perform different modulation from modulator 320b. Using multi-codeword transmission, a CRC check may optionally be performed on each of the codewords before the codeword is canceled form the overall signal at receiver 210. When this check is performed, interference propagation may be avoided in the cancellation process by ensuring that only correctly received codewords are canceled.

FIG. 4 illustrates details of spatial processing block 250 according to an embodiment of the present disclosure. For this embodiment, spatial processing block 250 comprises an optional inter-stream interference canceller 405, a channel estimator 410, a decoding order selector 415, a decoder 420, an optional validator 425, a reconstructor 430, and a reconstructed signal canceller 435. It will be understood that spatial processing block 250 may comprise other components not illustrated in FIG. 4. In addition, although illustrated as separate components, it will be understood that any two or more of inter-stream interference canceller 405, channel estimator 410, decoding order selector 415, decoder 420, validator 425, reconstructor 430, and reconstructed signal canceller 435 may be implemented together as a single component without departing from the scope of the present disclosure.

Optional inter-stream interference canceller 405 is operable to cancel inter-stream interference received from transmitters other than transmitter 205. For a particular embodiment, inter-stream interference canceller 405 is operable to perform a Linear Minimum Mean Square Error (LMMSE) operation to suppress inter-stream interference. Channel estimator 410 is operable to estimate the channels used for communication between transmitter 205 and receiver 210.

Decoding order selector 415 comprises a decoding prediction metric (DPM) calculator 450 and a sorter 455. As described in more detail below, DPM calculator 450 is operable to calculate a DPM for each data stream 265 to be used in decoding the streams 265. The DPM for each data stream 265 is based on a strength-related characteristic associated with the data stream 265. Thus, for example, the DPM may be based on a capacity of the channel associated with the data stream 265, an effective signal-to-interference and noise ratio (SINR) for the data stream 265 and/or any other suitable characteristic related to the strength of the data stream 265.

After calculating the DPMs, DPM calculator 450 may also be operable to weight the DPMs differently based on different types of modulation and coding performed by encoder 220 on different data streams 230. Generally, data streams 230 transmitted using a more robust modulation and coding will have a higher weight in the decoding prediction metric because such a stream 230 is more likely to be decoded successfully. For example, if a first data stream 230a is modulated using QPSK modulation and a second data stream 230b is modulated using 16-QAM modulation, the first data stream 230a is more likely to be decoded successfully even when the two streams 230a and 230b have the same effective SINR.

Sorter 455 is operable to sort the decoding order for streams 265 based on the DPM values. Thus, for example, sorter 455 may be operable to determine a first stream 265 to be decoded based on which stream 265 has a highest DPM, followed by the stream 265 with the next highest DPM, and so on.

Decoder 420 is operable to decode a stream 265 based on the decoding order determined by sorter 455. Thus, decoder 420 is operable to decode each of the streams 265 in the order specified by the decoding order. Optional validator 425 is operable to validate each of the decoded streams 265. For example, validator 425 may be operable to perform a CRC check on each stream 265 decoded by decoder 420 to verify that the decoded stream 265 is accurate.

Reconstructor 430 is operable to reconstruct the received signal in combined data stream 260 that corresponds to the stream 265 decoded by decoder 420. Reconstructor 430 is operable to reconstruct this signal based on the decoded stream 265 and the channel estimate provided by channel estimator 410 for the channel on which the signal was received. Thus, the signal reconstructed by reconstructor 430 is substantially equivalent to the transmitted data stream 230 as received at receiver 210.

After the received signal for a stream 265 is reconstructed by reconstructor 430, reconstructed signal canceller 435 is operable to cancel the reconstructed signal from the combined data stream 260 received from transmitter 205. Thus, as each signal is reconstructed and canceled from the combined data stream 260, the combined data stream 260 comprises a fewer number of streams 265 for decoding.

For one example of a particular embodiment, MIMO system 200 may comprise a multi-codeword-modulation (MCM) M×M system, where M is the number of transmit and receive antennas 225 and 255. Without loss of generality, the number of data streams 230 to be transmitted may be assumed to be M also. This MIMO system 200 operates in the spatial multiplexing mode. Each data stream 230 is individually encoded and modulated at transmitter 205 using multi-codeword modulation. At receiver 210, the received data from the M receive paths are combined into a combined data stream 260.

Each data stream 265 is separated and extracted from the combined data stream 260 using an MMSE-SIC algorithm. The MMSE-SIC algorithm detects signal components or data streams 265 one at a time by repeatedly applying an MMSE algorithm. After one signal component or data stream 265 is extracted, the data stream 265 passes through a virtual channel for that data stream 265 and is then subtracted or cancelled from the combined data stream 260. Therefore, for each subsequent application of MMSE, the dimension of the underlying system is reduced by one. This process is called successive interference cancellation (SIC) since each detected data stream 265 acts as interference for the detection of the remaining data streams 265.

The order in which the successive interference cancellation is performed on the data streams 265 has an enormous impact on the performance of MMSE-SIC. Thus, the most effective SIC process may be achieved by detecting and canceling the strongest signal component, or data stream 265, at each stage of the SIC process.

For systems in which no channel coding or weak channel coding is employed, MMSE-SIC generally performs better than MMSE. However, when a strong channel coding technique is in place, MMSE often outperforms MMSE-SIC even though MMSE-SIC is a more complex process. This is because conventional MMSE-SIC schemes perform the signal separation and extraction before channel decoding.

When errors occur, two adverse effects may result. First, the reconstructed data stream includes the errors. Thus, when subtracted from the combined data stream, some of the data structures embedded in the remaining data streams due to encoding are damaged or destroyed. This causes the effectiveness of the channel coding to be degraded. Second, the errors appearing in data streams detected previously are propagated into the later detection processes of the remaining data streams.

In order to overcome these shortcomings, one appraoch is to perform the data subtraction, or interference cancellation, on a post-decoding basis. That is, the detected data stream is first decoded to remove or reduce the error bits. These “clearner” bits are re-encoded, modulated and passed through the virtual channel for that stream and then are canceled from the combined data stream. However, though straightforward in appearance, this approach poses a number of implementation and system issues. To describe these issues, a review of the data model for the MIMO detection problem is provided herein.

Assume that the wireless channel remains constant for a period of one OFDM symbol and h_{j,i}(k,t) is the response of the wireless channel from the transmitter i to the receiver j at the sub-carrier k and the OFDM symbol t. Typically, a channel coding block covers a number of OFDM symbols. Assuming this number is T and the number of the sub-carriers is K, then 1≦t≦T and 1≦k≦K. The data model of the MIMO system at the given sub-carrier k and the OFDM symbol t may then be written as:

$$\tilde{\underline{r}} ( k , t ) = [ \begin{matrix}{h}_{1 , 1} ( k , t ) & {h}_{1 , 2} ( k , t ) & ⋯ & {h}_{1 , M} ( k , t ) \\ {h}_{2 , 1} ( k , t ) & {h}_{2 , 2} ( k , t ) & ⋯ & {h}_{2 , M} ( k , t ) \\ ⋮ & ⋮ & ⋰ & ⋮ \\ {h}_{M , 1} ( k , t ) & {h}_{M , 2} ( k , t ) & ⋯ & {h}_{M , M} ( k , t )\end{matrix} ] [ \begin{matrix}{s}_{1} ( k , t ) \\ {s}_{2} ( k , t ) \\ ⋮ \\ {s}_{M} ( k , t )\end{matrix} ] + \underline{w} ( k , t ) \qquad ( 1 )$$

where w(k,t) is the additive white Gaussian noise vector and \tilde{r}(k,t) is the received data vector. Note that the channel matrix may be further written as:

$$\begin{matrix}H ( k , t ) = [ \begin{matrix}{h}_{1 , 1} ( k , t ) & {h}_{1 , 2} ( k , t ) & ⋯ & {h}_{1 , M} ( k , t ) \\ {h}_{2 , 1} ( k , t ) & {h}_{2 , 2} ( k , t ) & ⋯ & {h}_{2 , M} ( k , t ) \\ ⋮ & ⋮ & ⋰ & ⋮ \\ {h}_{M , 1} ( k , t ) & {h}_{M , 2} ( k , t ) & ⋯ & {h}_{M , M} ( k , t )\end{matrix} ] \\ = [ {\underline{h}}_{1} ( k , t ) ⋯ {\underline{h}}_{m} ( k , t ) ⋯ {\underline{h}}_{M} ( k , t ) ] ,\end{matrix} \qquad ( 2 )$$

where hₘ(k,t) is the channel vector associated with the data stream m.

For one particular embodiment, spatial processing block 250 is operable to perform a post-decoding SIC algorithm that comprises the following five steps:
a) Calculate a decoding prediction metric for each data stream and determine the order in which the M data streams are to be decoded;
b) Perform MMSE on the combined data stream to extract the strongest data stream;
c) After detecting and decoding this data stream, re-encode, modulate, and pass the data stream through the virtual channel for that data stream, and subtract the result from the combined data stream;
d) Reformulate the decoding problem to reflect the removal of the decoded data stream(s);
e) Repeat steps (b) through (d) until all M data streams are obtained.

### Alternatives may include validating decoded data streams and/or repeating steps (a) through (d) instead of steps (b) through (d) at step (e), in addition to any other suitable alternatives.

Following is one example of an approach to the determination of the decoding order. First, the quantities Cₘ, m=1,2, . . . ,M, are obtained as follows:

$${C}_{m} = \frac{1}{T \cdot K} {\sum }_{i = 1}^{T} {\sum }_{k = 1}^{K} \{ {log}_{2} ( 1 + {\underline{h}}_{m}^{*} ( k , t ) \cdot {\underline{h}}_{m} ( k , t ) ) \} , \qquad ( 3 )$$

where h*ₘ(k,t) is the Hermitian (complex-conjugate transpose) of hₘ(k,t) Then a decoding prediction metric (DPM), Dₘ, may be defined as follows:

Dₘ=2^{C}^{ₘ}−1, m=1,2, . . . ,M.

For this embodiment, sorting the Dₘ values in descending order results in the decoding order for the SIC process, i.e., the data stream that has the largest quantity of D is considered the strongest for the purpose of successive interference cancellation.

Besides Equation (3), alternative algorithms may be used to calculate Cₘ. Consider the MMSE filter for MMSE detection in an additive white noise environment. Such a filter at a given sub-carrier k and OFDM symbol t may be expressed as:

G=H{H*H+(σ₀²/σₛ²)·I}⁻¹=└g₁g₂ . . . g_{M}┘ (4)

Note that, in the above equation, the sub-carrier index k and OFDM symbol index t have been omitted for simplicity. Thus, the following equation results:

$$\hat{\underline{s}} = {G}^{*} H \underline{s} + {G}^{*} \underline{w} = [ \begin{matrix}{\underline{g}}_{1}^{*} \\ {\underline{g}}_{2}^{*} \\ ⋮ \\ {\underline{g}}_{M}^{*}\end{matrix} ] ⌊ {\underline{h}}_{1} {\underline{h}}_{1} ⋯ {\underline{h}}_{M} ⌋ \underline{s} + {G}^{*} \underline{w} . \qquad ( 5 )$$

In the case of M=2, for example, Equation (5) may be written as:

$$\hat{\underline{s}} = [ \begin{matrix}{\underline{g}}_{1}^{*} \\ {\underline{g}}_{2}^{*}\end{matrix} ] ⌊ {\underline{h}}_{1} {\underline{h}}_{2} ⌋ \underline{s} + [ \begin{matrix}{\underline{g}}_{1}^{*} \\ {\underline{g}}_{2}^{*}\end{matrix} ] \underline{w} = [ \begin{matrix}{α}_{11} & {α}_{12} \\ {α}_{21} & {α}_{22}\end{matrix} ] \underline{s} + [ \begin{matrix}{\underline{g}}_{1}^{*} \\ {\underline{g}}_{2}^{*}\end{matrix} ] \underline{w} .$$

The signal-to-interference and noise ratio (SINR) for data stream 1 may be defined as:

$$SIN {R}_{1} = \frac{{\vert {α}_{11} \vert}^{2}}{{\vert {α}_{12} \vert}^{2} + {\vert {\underline{g}}_{1} \vert}^{2} {σ}_{0}^{2} / {σ}_{s}^{2}} ,$$

and the SINR for data stream 2 may be defined as:

$$SIN {R}_{2} = \frac{{\vert {α}_{22} \vert}^{2}}{{\vert {α}_{21} \vert}^{2} + {\vert {\underline{g}}_{2} \vert}^{2} {σ}_{0}^{2} / {σ}_{s}^{2}} .$$

With the above definitions, another form of Cₘ, for an arbitrary M, may be defined as:

$$\begin{matrix}{C}_{m} = \frac{1}{T \cdot K} {\sum }_{t = 1}^{T} {\sum }_{k = 1}^{K} \{ {log}_{2} ( 1 + SIN {R}_{m} ) \} \\ = \frac{1}{T \cdot K} {\sum }_{t = 1}^{T} {\sum }_{k = 1}^{K} \{ {log}_{2} ( 1 + \frac{{\vert {α}_{mm} \vert}^{2}}{{\sum }_{n = 1 \\ n \neq m}^{M} {\vert {α}_{mn} \vert}^{2} + {\vert {\underline{g}}_{m} \vert}^{2} {σ}_{0}^{2} / {σ}_{s}^{2}} ) \} .\end{matrix} \qquad ( 6 )$$

Following is another alternative, which is a simplified version of Equation (6), that may be used:

$${C}_{m} = \frac{1}{T \cdot K} {\sum }_{t = 1}^{T} {\sum }_{k = 1}^{K} \{ {log}_{2} ( 1 + {\vert {α}_{mm} \vert}^{2} ) \} . \qquad ( 7 )$$

Note that the expression of Cₘ has the common format of:

$${C}_{m} = \frac{1}{T \cdot K} {\sum }_{t = 1}^{T} {\sum }_{k = 1}^{K} \{ {log}_{2} ( 1 + {E}_{m} ) \} .$$

### In practice, a performance equivalent format of Cₘ is:

$${C}_{m} = \frac{1}{T \cdot K} {\sum }_{t = 1}^{T} {\sum }_{k = 1}^{K} \{ {E}_{m} \} .$$

### In addition, it will be understood that other suitable alternative definitions of Cₘ may be used.

In the case of an OFDM-MIMO system, different streams may experience different effective SINR. The relative effective SINR between different MIMO streams is another example of a decoding prediction metric that may be used by spatial processing block 250. In general, a stream with a larger effective SINR is more likely to be decoded successfully than a stream with a smaller effective SINR. The effective SINR takes into account the variations of SINR over the frequency spectrum on which the stream is transmitted.

An approach called Exponential Effective SINR Mapping (EESM) is shown to capture the penalty in effective SINR due to frequency-selective fading on OFDM sub-carriers. The effective SINR using this approach is given as:

$$SIN {R}_{eff} = - β ln ( \frac{1}{{N}_{u}} {\sum }_{i = 1}^{{N}_{u}} {e}^{- \frac{SIN {R}_{i}}{β}} )$$

where SINRᵢ is the SINR observed at sub-carrier i. This effective SINR on different MIMO streams may also be used to select the decoding order.

FIG. 5 is a flow diagram illustrating a method 500 for decoding data streams 265 using spatial processing block 250 according to an embodiment of the present disclosure. The steps shown with dashed lines around them (505, 530, 550, 555 and 560) are optional, as described in more detail below.

Initially, for the embodiment of spatial processing block 250 that comprises an inter-stream interference canceller 405, inter-stream interference canceller 405 may cancel inter-stream interference in combined data stream 260 (process step 505). For a particular embodiment, an LMMSE operation is performed to suppress the inter-stream interference. Channel estimator 410 estimates the channels used for communicating data streams 230 (process step 510).

DPM calculator 450 of decoding order selector 415 calculates a decoding prediction metric (DPM) for each data stream 265 to be decoded (process step 515). DPM calculator 450 may calculate the DPMs based on capacity for the channel associated with the data stream 265, effective SINR for the data stream 265 and/or any other suitable strength-related characteristic. For some embodiments, DPM calculator 450 may calculate the DPMs based on one of the methods for calculating Cₘ described above in connection with FIG. 4. In addition, for a particular embodiment in which encoder 220 may perform different types of modulation and coding on the different data streams 230, DPM calculator 450 may adjust the DPMs to give different weights to the different modulation and coding types.

Sorter 455 of decoding order selector 415 sorts a decoding order for the data streams 265 based on the DPMs calculated by DPM calculator 450 (process step 520). For example, sorter 455 may sort the decoding order of the data streams 265 in descending order of the values of the DPMs so that the data stream 265 having the highest DPM is first in the decoding order and the data stream 265 having the lowest DPM is last in the decoding order. Decoder 420 decodes the data stream 265 that is first in the decoding order (process step 525).

By using the decoding order determined by sorter 455 based on DPMs, the data stream 265 will generally be decoded accurately by decoder 420 because the data stream 265 will generally be the strongest stream 265. However, if desired, an optional validating step may be performed to verify that the data stream 265 was decoded accurately by decoder 420. For this embodiment, validator 425 may verify the accuracy of the decoded data stream 265 (process step 530). For example, validator 425 may perform a CRC check on the data stream 265.

If validator 425 verifies the accuracy of the decoded data stream 265 (process step 530) or if optional step 530 is omitted, reconstructor 430 then reconstructs the received signal for the data stream 265 based on the decoded data stream 265 and the channel estimate for the channel over which the data stream 265 was received (process step 535). Thus, reconstructor 430 essentially reconstructs the data stream 230 (corresponding to decoded data stream 265) as received at receiver 210 after transmission over the channel of wireless interface 215.

Reconstructed signal canceller 435 cancels the reconstructed signal from the combined signal 260 (process step 540). Thus, after cancellation, the remaining combined signal 260 comprises the streams 265 remaining to be decoded without any of the previously decoded data streams 265.

After this cancellation is performed (process step 540) or if validator 425 cannot verify the accuracy of the decoded data stream 265 (optional process step 530), spatial processing block 250 determines whether the combined signal 260 comprises any more data streams 265 to be decoded (process step 545). If no data streams 265 remain to be decoded (process step 545), the decoding process is complete and the method comes to an end.

However, if more data streams 265 remain to be decoded (process step 545), the method continues. For one embodiment, the method returns to step 525, where decoder 420 decodes the next data stream 265 in the decoding order (process step 525) and the method continues as before. For another embodiment, optional step 550 and/or optional steps 555 and 560 may be performed before returning to step 525.

Thus, for some embodiments, inter-stream interference canceller 405 may cancel inter-stream interference in the remaining combined data stream 260 using, for example, an LMMSE operation (process step 550). In addition, for some embodiments, DPM calculator 450 may recalculate a DPM for each data stream 265 remaining to be decoded (process step 555), and sorter 455 may re-sort the decoding order for the data streams 265 based on the recalculated DPMs (process step 560).

In this way, interference cancellation may be performed by decoding data streams 265 in a logical order, thereby minimizing potential errors without introducing undue complexity into receiver 210. This is possible because decoding order selector 415 is capable of calculating a DPM based on a strength-related characteristic for each data stream 265 so that the data stream 265 most likely to be strongest is decoded first.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for decoding a plurality of data streams from a combined data stream in a Multiple Input/Multiple Output (MIMO) system, comprising:
selecting a decoding order for the data streams based on a decoding prediction metric for each of the data streams; and
decoding the data streams based on the decoding order.

2. The method as set forth in claim 1, selecting the decoding order for the data streams comprising:
calculating the decoding prediction metric for each of the data streams; and
sorting the decoding order based on the decoding prediction metrics.

3. The method as set forth in claim 2, calculating the decoding prediction metric for each of the data streams comprising calculating the decoding prediction metric based on a channel capacity associated with the data stream.

4. The method as set forth in claim 2, calculating the decoding prediction metric for each of the data streams comprising calculating the decoding prediction metric based on an effective signal-to-interference and noise ratio (SINR) associated with the data stream.

5. The method as set forth in claim 2, selecting the decoding order for the data streams further comprising weighting each decoding prediction metric based on a modulation and coding type for the data stream.

6. The method as set forth in claim 1, further comprising:
estimating a channel for each data stream;
after decoding each data stream, reconstructing a received signal for the data stream based on the decoded data stream and the channel estimate for the data stream; and
canceling the reconstructed signal from the combined data stream.

7. The method as set forth in claim 1, further comprising canceling inter-stream interference from the combined data stream before decoding the plurality of data streams.

8. The method as set forth in claim 7, canceling inter-stream interference from the combined data stream comprising performing a Linear Minimum Mean Square Error (LMMSE) operation on the combined data stream.

9. The method as set forth in claim 1, further comprising, after decoding each data stream, validating the decoded data stream.

10. The method as set forth in claim 9, validating the decoded data stream comprising performing a cyclic redundancy code (CRC) check on the decoded data stream.

11. A system for decoding a plurality of data streams from a combined data stream in a MIMO system, comprising:
a decoding order selector operable to select a decoding order for the data streams based on a decoding prediction metric for each of the data streams; and
a decoder operable to decode the data streams based on the decoding order.

12. The system as set forth in claim 11, the decoding order selector comprising:
a decoding prediction metric (DPM) calculator operable to calculate the decoding prediction metric for each of the data streams; and
a sorter operable to sort the decoding order based on the decoding prediction metrics.

13. The system as set forth in claim 12, the DPM calculator operable to calculate the decoding prediction metric for each of the data streams based on a channel capacity associated with the data stream.

14. The system as set forth in claim 12, the DPM calculator operable to calculate the decoding prediction metric for each of the data streams based on an effective SINR associated with the data stream.

15. The system as set forth in claim 12, the DPM calculator further operable to weight each decoding prediction metric based on a modulation and coding type for the data stream.

16. The system as set forth in claim 11, further comprising:
a channel estimator operable to estimate a channel for each data stream;
a reconstructor operable, after the decoder decodes each data stream, to reconstruct a received signal for the data stream based on the decoded data stream and the channel estimate for the data stream; and
a reconstructed signal canceller operable to cancel the reconstructed signal from the combined data stream.

17. The system as set forth in claim 11, further comprising an inter-stream interference canceller operable to cancel inter-stream interference from the combined data stream before decoder decodes the plurality of data streams.

18. The system as set forth in claim 17, the inter-stream interference canceller operable to cancel inter-stream interference from the combined data stream by performing a LMMSE operation on the combined data stream.

19. The system as set forth in claim 11, further comprising a validator operable, after the decoder decodes each data stream, to validate the decoded data stream.

20. The system as set forth in claim 19, the validator operable to validate the decoded data stream by performing a CRC check on the decoded data stream.

21. A receiver capable of decoding a plurality of data streams from a combined data stream in a MIMO system, comprising:
a plurality of receive antennas operable to receive the combined data stream from a transmitter, the combined data stream comprising the plurality of data streams, each data stream transmitted by one of a plurality of transmit antennas at the transmitter; and
a spatial processing block coupled to the receive antennas, the spatial processing block operable to decode the plurality of data streams from the combined data stream based on a decoding prediction metric for each of the data streams.

22. The receiver as set forth in claim 21, the spatial processing block comprising:
a decoding order selector operable to select a decoding order for the data streams based on the decoding prediction metric for each of the data streams; and
a decoder operable to decode the data streams based on the decoding order.

23. The receiver as set forth in claim 22, the decoding order selector comprising:
a DPM calculator operable to calculate the decoding prediction metric for each of the data streams; and
a sorter operable to sort the decoding order based on the decoding prediction metrics.

24. The receiver as set forth in claim 23, the DPM calculator operable to calculate the decoding prediction metric for each of the data streams based on a channel capacity associated with the data stream.

25. The receiver as set forth in claim 23, the DPM calculator operable to calculate the decoding prediction metric for each of the data streams based on an effective SINR associated with the data stream.

26. The receiver as set forth in claim 23, the DPM calculator further operable to weight each decoding prediction metric based on a modulation and coding type for the data stream.

27. The receiver as set forth in claim 22, the spatial processing block further comprising:
a channel estimator operable to estimate a channel for each data stream;
a reconstructor operable, after the decoder decodes each data stream, to reconstruct a received signal for the data stream based on the decoded data stream and the channel estimate for the data stream; and
a reconstructed signal canceller operable to cancel the reconstructed signal from the combined data stream.

28. The receiver as set forth in claim 22, the receive antennas further operable to receive inter-stream interference, the spatial processing block further comprising an inter-stream interference canceller operable to cancel inter-stream interference from the combined data stream before decoder decodes the plurality of data streams.

29. The receiver as set forth in claim 22, the spatial processing block further comprising a validator operable, after the decoder decodes each data stream, to validate the decoded data stream.
